(19) United States
(12) Patent Application Publication
(10) Pub. No.: US 2010/0320264 A1
(43) Pub. Date: Dec. 23, 2010

(54) PLATES CONTAINER CHARACTERISTICS MANAGEMENT SYSTEM

(76) Inventor: Shay Amsili, Kfar Yona (IL)

Correspondence Address: Raymond L. Owens;Patent Legal Staff, Eastman Kodak Company, 343 State Street, Rochester, NY, 14650-2201, US

(21) Appl. No.: 12/488,606

(22) Filed: Jun. 22, 2009

(51) Int. Cl. G06F 17/00

(52) U.S. Cl. 235/375

(57) ABSTRACT

A plate management system (10) including a plate container (24) configured to store plates to be imaged, a read-write memory element (26) adapted to store plate characteristics information of the plates, and a controller (34) configured to write, update, and restore the characteristics information by using a communication interface attached to the memory element.

### CROSS REFERENCE TO RELATED APPLICATIONS

Reference is made to commonly-assigned copending U.S. patent application Ser. No. 12/045,061, filed Mar. 10, 2008, entitled PLATE PALLET STOCK DETECTION, by Korolik et al., the disclosure of which is incorporated herein.

### FIELD OF THE INVENTION

This present invention relates to an apparatus and methods to save and retrieve characteristics of plates on a plate container sometimes referred to as a plate pallet, a tray, or a cassette used with a computer to plate (CTP) imaging device.

### BACKGROUND OF THE INVENTION

A variety of systems and applications use stack of sheets or plates, which may be made of metal, paper, plastic, or the like. Printing plates (hereinafter singly or collectively referred to as “plates”) are typically stacked in a plate container which houses the plates and facilitates their protection, transportation, and handling.

A system for handling printing plates will generally use plate containers having specific dimensions. Plate containers can usually be set to contain plates of various sizes, but all plates in the same plate containers are of one size. The plates may be manually removed from a shipping container and inserted into the plate containers for use by the plate imaging system. Plates packed in plate containers are separated by intermediate paper sheets, hereinafter referred to as ‘separation paper.’

Plate containers containing printing plates are heavy and bulky, and moving such trays up and down requires complicated and expensive mechanisms and is time consuming. There is a widely recognized need for an automatic and efficient handling system for feeding plates directly from the original plate containers into the imaging device, while maintaining precise alignment of the plate during the plate feeding process.

### SUMMARY OF THE INVENTION

Briefly, according to one aspect of the present invention a plate management system including a plate container configured to store plates to be imaged, a memory element adapted to store plate characteristics information of the plates, and a controller configured to write, update and restore the characteristics information by using a communication interface attached to the memory element.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a perspective view of a plate management system;

FIG. 2 is a perspective view of a of a plate loading system using a plate management system according to the present invention; and

FIG. 3 is a perspective view of an automatic plate loading system according to the present invention connected to a plate imaging device.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

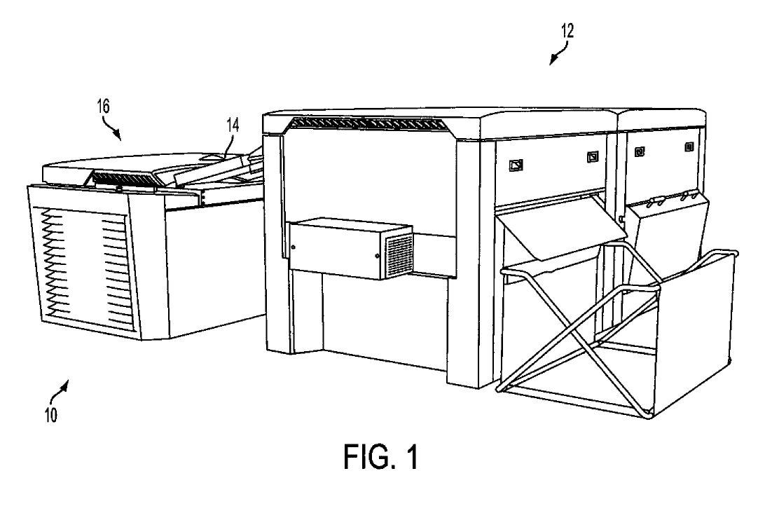

The present invention describes methods and a system for storing and retrieving characteristics of printing plates during printing plate preparation process. FIG. 1 shows a typical printing plate preparation system 10. Printing plate preparation system 10 includes a plate imaging device 16 and a plate pallet loader 12, configured to supply plates into imaging device 16 through a connecting plate tray 14. Alternatively a plate loader may be at least one plate tray configured to supply plates to imaging device 16.

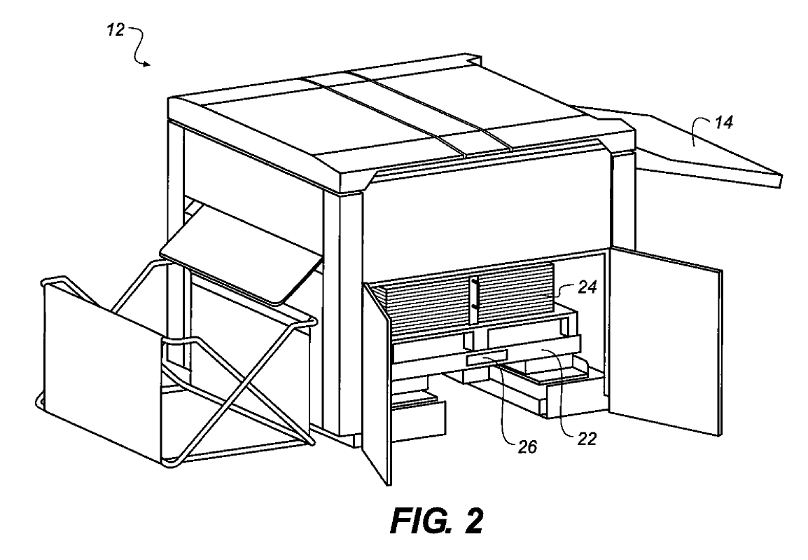

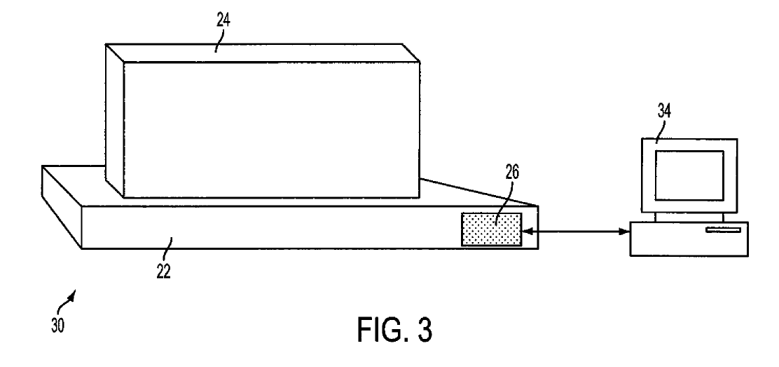

FIG. 2 shows plate loader 12. Plate container 24, in this case a plate pallet, is positioned on plate pallet adapter 22. A read-write memory element 26 is attached to plate pallet adapter 22. FIG. 3 describes plate pallet system 30, the plate pallet system 30 is comprised of, a plate pallet adapter 22, a plate container 24 positioned on the plate pallet adapter, and a read-write memory element 26. Controller 34, in this example a computer, is adapted to control the plate preparation process.

Read-write memory element 26 stores plate characteristics information. The parameters may include:
1. Fixed parameters such as plate type, plate vendor, or other fixed plate information. This type of parameters can be written to read-write memory element 26 at the plate manufacturer site, and delivered as part of the plate containers to the printing site.
2. Dynamic parameters such as number of remaining unused plates, pallet position on pallet adaptor. This information is updated during the plate imaging process and is written back to read-write memory element 26.
3. Parameters which are dependent upon fixed plate parameters. Those parameters may include plate exposure parameters. Such set of parameters can be specific for a plate type, for example, and will be automatically loaded into the system, when the plate type is being used. The dependent parameters are written into read-write memory element 26 by controller 34, upon detection of a plate pallet containing specific plate type.

A system operator operates controller 34. The operator will enter parameters, representing plate characteristic information essential for plate imaging process, into controller 34. The parameters include at least the following information: plate name, plate type, plate quantity, plate size, plate thickness, plate vendor, plate sensitivity, plate positioning, and exposure information.

The parameters are saved and updated as needed during the plate preparation process in the read-write memory element 26. The data transfer between controller 34 and read-write memory element 26 may be performed by wireless means such as Bluetooth, or radio frequency for example. Read-write memory element 26 is attached to a plate container 24 or plate adapter 22 by the plate pallet manufacturer and the read-write memory element 26 is updated by plate manufacturer with suitable information such as number of plates in the pallet, plates type, plate size. During the plate imaging process additional parameters are loaded to read-write memory element 26. This information may include plate position on the imaging device 16 drum, for example. Dynamic information such as the number of plates in plate container 24 is updated during plates imaging process.

In a typical plate imaging process an operator will load a new plate container 24 into the imaging device 16. Controller 34 will automatically read plate pallet characteristic from the read-write memory element 26, such as number of plates in pallet, plate type vendor, and vendor. Controller 34 will automatically assign exposure parameters, e.g. reflectivity, laser power, drum speed, to be used at the imaging stage of the plates fetched from plate container 24. The exposure parameters will be selected according to the plate pallet characteristic read from read-write memory element 26.

In another example the operator may swap a first plate container 24 with a second plate container, wherein the second plate container carries plates with a different plate type. Plate container 24 will update the dynamic parameters in read-write memory element 26 in the first plate container 24 prior to the swap. The second plate container will be entered into the system for operation. At the stage where the first plate container 24 will be reentered into the system, the dynamic parameters, such as plate's location and tilt on the plate pallet will take effect automatically without operator intervention.

The invention has been described in detail with particular reference to certain preferred embodiments thereof, but it will be understood that variations and modifications can be effected within the scope of the invention.

### PARTS LIST

10 printing plate preparation system
12 plate pallet loader
14 connecting plate tray
16 imaging device
22 plate pallet adaptor
24 plate container
26 read-write memory element
30 plate pallet system
34 controller

1. A plate management system comprising:
a plate container for storing non-imaged imaging plates;
a memory element attached to said plate container wherein said memory element is adapted to store plate characteristics and wherein at least some of said plate characteristics are preloaded by the manufacturer of printing plates in said plate container;
a controller for writing, updating, and restoring plate characteristics in said memory element; and
a communication interface attached to said memory element for communicating between said controller and said memory element.

2. The plate management system of claim 1 wherein said plate container is a tray.

3. The plate management system of claim 1 wherein said plate container is a plate pallet wherein said plate pallet comprises a plurality of non-imaged printing plates originally packaged by the manufacturer of said printing plates.

4. The plate management system of claim 1 wherein said memory element is a radio frequency identification (RFID) element.

5. The plate management system of claim 1 wherein said memory element is a flash memory.

6. The plate management system of claim 1 wherein said memory element is an erasable programmable read-only memory (EPROM).

7. The plate management system of claim 1 wherein said characteristics are selected from a group comprising one or more of plate name, plate type, plate quantity, plate size, plate thickness, plate vendor, plate sensitivity, plate positioning, exposure information, or combinations thereof.

8. The plate management system of claim 1 wherein said interface is wireless.
